(19) United States
(12) Patent Application Publication
(10) Pub. No.: US 2008/0223645 A1
(43) Pub. Date: Sep. 18, 2008

(54) Automobile anti-theft and start control device to encourage wearing of seatbelts

(76) Inventor: Kenneth S. Shaw, Staten Island, NY (US)

Correspondence Address: Mitchell A. Stein, Esq.;STEIN LAW, P.C., Suite 4, 24 Woodbine Avenue, Northport, NY, 11768, US

(21) Appl. No.: 11/717,353

(22) Filed: Mar. 13, 2007

(51) Int. Cl. B60R 21/00

(52) U.S. Cl. 180/270

(57) ABSTRACT

A seat belt switching device for preventing the running of a vehicle optionally having a remote starting ability, key operated ignition switch, neutral safety switch, seat belt switch, solenoid and starter, having a wiring of the seat belt switch such that the solenoid is not actuated unless and until the seat belt switch is engaged indicative of a seat belt being connected such that if not connected, the vehicle does not run. The seat belt switch has a fastened and unfastened position such that when in a fastened position a circuit is closed to the solenoid, actuating the starter and when in an unfastened position the circuit is open to the solenoid thereby failing to engage the solenoid and failing to permit operation of the vehicle. In one embodiment, the opening and closing occurs after the neutral safety switch. In another, the opening and closing occurs prior to the neutral safety switch.

### FIELD OF THE INVENTION

The present invention relates to the field of automobiles, and more particularly to an automobile anti-theft and start control system and method which utilizes existing components of an automobile to encourage the wearing of automobile seatbelts.

### BACKGROUND OF THE INVENTION

Use of automobile seatbelts is known to decrease the risk of fatality in traffic crashes, as well as the risk of moderate to critical injury, in an automobile crash. Indeed, studies have shown that seatbelts, when used properly, reduce the risk of fatal injury to front-seat passenger car occupants by 45 percent and the risk of moderate to critical injury by 50 percent. However, according to a recent report released by the National Highway Traffic Safety Administration (NHTSA), 48,000,000 Americans fail to regularly wear seatbelts when driving or riding in an automobile. In 2001, almost 60 percent of passenger vehicle occupants killed in traffic crashes were unrestrained. Failure to use seatbelts also results in significant economic costs to society. NHTSA estimates that the deaths and injuries from unrestrained occupants of automobiles result in $26 billion in economic costs to society annually, largely in the form of higher taxes, and higher health care and insurance costs.

In response to the impact of the failure to use seatbelts, lawmakers have passed various mandatory seatbelt laws, with fines for non-compliance, in an attempt to encourage the use of seatbelts. For example, 22 states, the District of Columbia and Puerto Rico have passed seatbelt laws allowing a law enforcement officer to stop a vehicle and issue a citation for failure to wear a seatbelt if the officer observes that one or more of the occupants are not wearing their seatbelt(s). The remaining states, save New Hampshire, have passed seatbelt laws which allow a law enforcement officer to issue a citation only if the officer stops the vehicle based on another infraction. Given the number of vehicles on the road each given day however, its impossible to effectively enforce such seatbelt laws.

Known in the art are devices which aid in monitoring seatbelt use, yet fail to provide a mechanism whereby the vehicle will be precluded from starting if one or more seatbelt is not properly engaged. For example, U.S. Pat. No. 6,215,395 to Slaughter, et. al. shows an apparatus and method for monitoring seatbelt use in a motor vehicle in which each seatbelt is equipped with an indicator which sends a signal to various displays located throughout the vehicle to verify the usage of individual seatbelts. The apparatus in Slaughter however fails to show a mechanism whereby the vehicle will be precluded from starting if one or more seatbelt is not properly engaged.

Also known in the art are devices which attempt, but fail, to compel seatbelt use among occupants of automobiles by providing a mechanism that prevents a vehicle from starting unless the driver's seatbelt is engaged. Previous attempts to compel seatbelt use among occupants of automobiles have failed to disclose a device that utilizes the existing components of an automobile to create a device which prevents a vehicle from starting unless the driver's seatbelt is engaged. For example, U.S. Pat. No. 4,107,645 to Lewis, et. al. shows a system wherein various sensors are used to detect whether a vehicle's front seat is occupied and the seatbelt is in the extended position, which then transmits signals to a “logic circuit” which will prevent the engine from starting if the driver's seat is unoccupied and the seatbelt extended. However, components such as the sensors and “logic circuit” are not standard equipment on automobiles and thus must be purchased separately and installed by a professional, resulting in increased cost, unreliability, and general “overkill” in operation.

It is thus an object of the instant invention to provide a system and method which prevents an automobile from starting start unless seatbelt(s) are engaged, which utilize existing components of an automobile (with additions) in order to compel seatbelt use.

A further object of the invention is to provide a system and method which prevents an automobile from starting start unless seatbelt(s) are engaged, which utilizes existing components of an automobile (with additions), that does not interfere with an automobile's remote start system.

A further object of the invention is to provide a system and method which prevents an automobile from starting start unless seatbelt(s) are engaged, which utilizes existing components of an automobile, which further provides anti-theft protection.

A further object of the invention is to provide a system and method which prevents an automobile from starting start unless seatbelt(s) are engaged, which utilizes existing components of an automobile (with additions), which is easily installed.

Further objects of the invention will become apparent as the entirety of the specification, drawings and claims are read and understood by one of ordinary skill in the art.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

In brief, a seat belt switching device is shown for preventing the running of a vehicle optionally having a remote starting ability, key operated ignition switch, neutral safety switch, seat belt switch, solenoid and starter, having a wiring of the seat belt switch such that the solenoid is not actuated unless and until the seat belt switch is engaged indicative of a seat belt being connected such that if not connected, the vehicle does not run. The seat belt switch has a fastened and unfastened position such that when in a fastened position a circuit is closed to the solenoid, actuating the starter and when in an unfastened position the circuit is open to the solenoid thereby failing to engage the solenoid and failing to permit operation of the vehicle. In one embodiment, the opening and closing occurs after the neutral safety switch. In another, the opening and closing occurs prior to the neutral safety switch.

In typical starting systems of modern automobiles, when the ignition key is turned, electricity flows from the power source, usually a battery, to the starter solenoid. Many modern vehicles also include a neutral safety switch, which runs from the ignition to the starter solenoid, and acts to block the signal (from the starter solenoid) to the power source if the vehicle is in gear (not in neutral or park). The starter solenoid consists essentially of an electromagnetic switch which is customarily mounted directly on the starter motor. When the coils inside the solenoid are provided with electricity, they create a magnetic field which moves the shift lever, which connects to the drive pinion and clutch assembly of the starter motor, thus preventing the flywheel of the starter motor from cranking and hence the vehicle from starting. Turning the ignition key however deactivates the solenoid, which releases the drive pinion springs from the flywheel of the starter motor, and allows the flywheel to crank the engine, and the vehicle to start.

Remote start systems used in most modern automobiles include a safety/anti-theft feature which prevents the automobile from being placed into gear (drive or reverse) unless the key is placed in the ignition. To achieve this feature, a neutral safety switch, which only allows power to pass to the starter solenoid if the vehicle is in park (or the clutch engaged in automobiles with standard transmissions), is employed. The neutral safety switch therefore only allowing the car to be placed in gear (and driven) if the key is inserted in the ignition.

Most modem automobiles include a seatbelt switch which connects to an indicator light, typically found on the dashboard, to detect whether the occupant of an automobile has fastened his or her seatbelt. When power is provided to an automobile via the power supply (usually a battery) and the seatbelt is not fastened, the connection between the seatbelt switch and indicator light is complete, therefore illuminating the indicator light. When the occupant's seatbelt is fastened however, the connection between the seatbelt switch and indicator light is broken, which typically causes the indicator light to go out.

Ordinarily, to start and operate an automobile, the driver must perform a certain sequence of events. For example, the neutral safety switch ensures that the vehicle's transmission is in either neutral or park before the vehicle is permitted to start. The instant invention teaches an automobile anti-theft and start control system and method in which a seatbelt switch, found in an ordinary automobile, is connected in series between the existing neutral safety switch and starter wire of the ignition switch, which will require that the user's seatbelt is fastened before the vehicle is permitted to start. As such, reconfiguring the seatbelt switch in series with the neutral safety switch and ignition switch will prevent the automobile from starting, unless the seatbelt is fastened and the transmission in park or neutral. The seatbelt switch continuously runs power when the vehicle is in the “on” position, hence the seatbelt switch will work in conjunction with the neutral safety switch without compromising the function of the same. In sum, the device of the instant invention adds an additional event, the fastening of a seatbelt, that must occur before the automobile is started and driven. Furthermore, the device disclosed in the instant invention will not interfere with the operation or safety features of typical remote start system.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is a is a diagrammatical view of the configuration of electronic components of the starting system of the preferred embodiment of the invention with reference to the prior design for comparative demonstration; and

FIG. 2 is a is a an alternative view of the configuration of electronic components of the seatbelt switch of another embodiment of the invention.

### DETAILED DESCRIPTION OF THE PREFERRED EMBODIMENTS

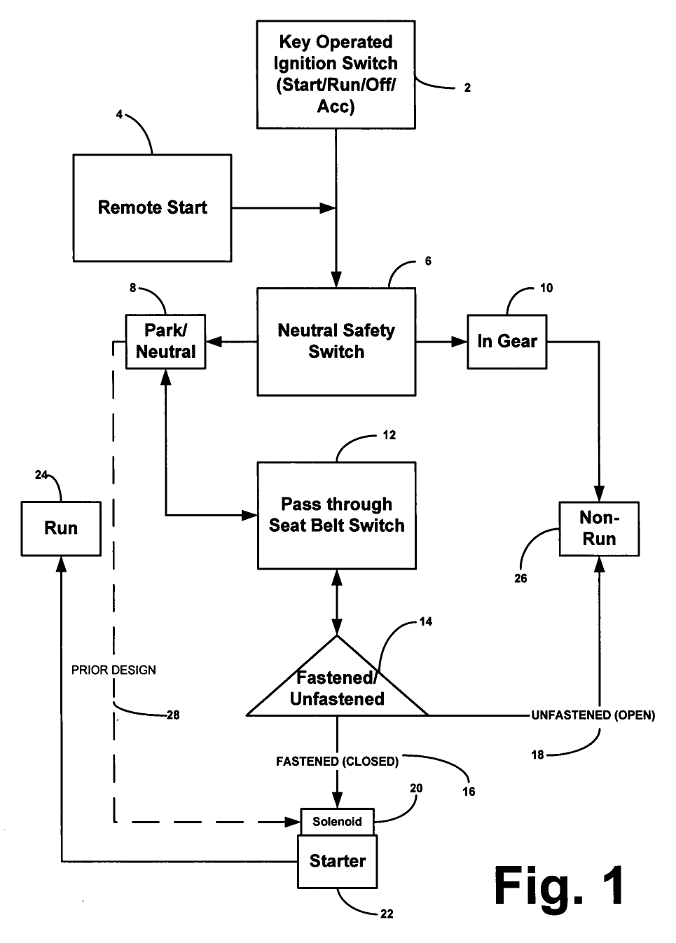

As shown in FIG. 1, key operating ignition switch 2 is a typical switch in normal cars that is key engaged and has the normal functions of start, run, off and accessories, as shown. Switch 2 electronically connects to neutral safety switch 6 (such that there is low power at switch 2) in order to operate amongst the options of switch 2.

As shown, remote start 4, which typically resides on a key fob (not shown) comprises an RF transmitter and receiver in an automobile, permitting the owner to start the engine prior to entry into the car, thereby creating the ability to regulate the interior temperature, for instance, prior to use of the car. The instant invention permits both operations—provided the seat belt is engaged, as explained in greater detail hereinbelow.

Neutral safety switch 6, in normal fashion, does not permit starting of the vehicle unless in park/neutral 6, and not when in gear 10. These features remain unchanged in the instant invention. However, the instant invention provides a mechanism to ensure that the automobile will not operate unless and until the seat belt for the driver is engaged. This is achieved by the use of pre-existing seat belt switch 12. In normal operation, an automobile will show a light on the dashboard (and perhaps also emit a sound) if the driver has failed to engage the seatbelt. In this invention, the driver cannot operate the vehicle unless and until the seat belt is engaged. Since the automobile already comprises a seat belt switch (wired, as it is, to a light to audio transmitter), the wiring is modified. When the automobile is properly in park/neutral 8, power typically passing through seat belt switch 12 is critical to the instant invention. If seat belt switch 12 is fastened at step 14, the by fastened, the circuit is closed at step 16, and solenoid 20 is engaged to start starter 22.

If unfastened at step 14, then the circuit is open (no lights or sounds) and solenoid 20 is not engaged, and the automobile will not run at 26—just like the situation if in gear via step 20. If engaged, then starter 22 is operative, and the automobile runs via step 24. This is achieved in that the wire that typically traverses to the light/audio output is instead wired such that if open (as in unfastened 18 the automobile fails to run and if closed, as in step 16, the solenoid 20 is engaged. The wire no longer is passed to a light or audible device when the belt is not closed (and the circuit is open) but instead no longer engages solenoid 20, and hence disengages the vehicle's operation. If closed at step 16, then the solenoid is actuated and the vehicle permitted to run at step 24.

In comparison, in the prior design 28, as long as the vehicle is in park/neutral 8, power is passed to solenoid 20, as shown in FIG. 1, regardless of whether the seat belt switch 12 is engaged. This “break” in the system decommissions the vehicle before it is operational, thereby requiring that the seat belt be engaged in order for solenoid 20 to engage starter 22.

It can also be observed that if the user leaves the vehicle with the seat belt engaged, then remote start 4 will function. Yet, if the user does not, the vehicle also will not start, as the open seat belt does not complete the circuit necessary to engage solenoid 20 and hence starter 22—the vehicle will not start.

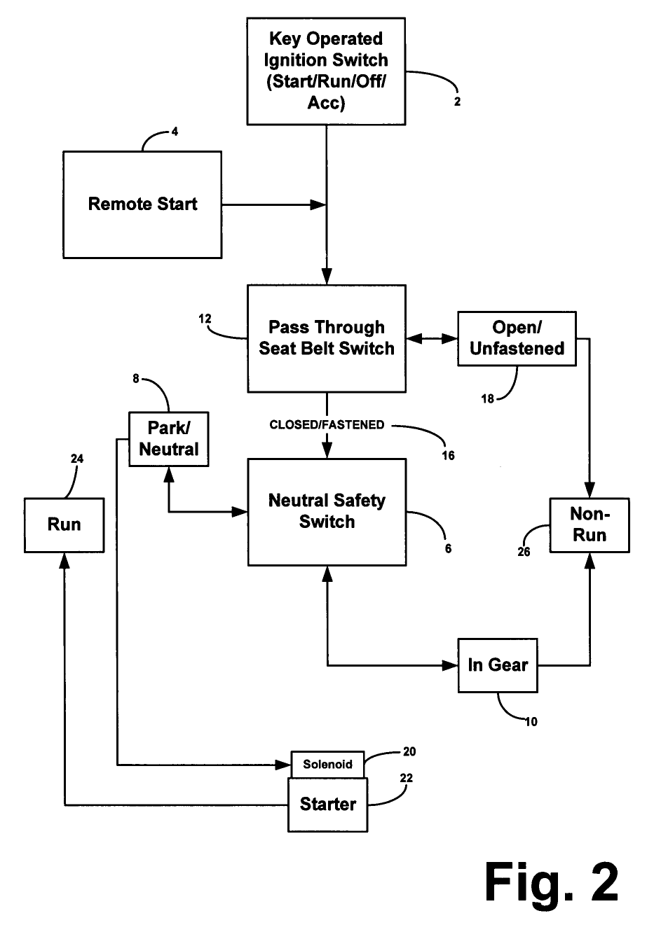

As shown in FIG. 2, an alternative embodiment is shown. Like components bear the same numerical references, yet, instead of breaking the connection to solenoid 20, the bresak is at neutral safety switch 6. Hence, when the seat belt is fastened/closed at step 16, neutral safety switch 6 is engaged. Otherwise, the open circuit at step 18 leaves the vehicle in non-run status 26.

In this manner, the vehicle owner is assured that should his seatbelt not be engaged, the vehicle will not operate, as solenoid 20 to starter 22 will, in either instance, not be powered to operate.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A seat belt switching device for preventing the running of a vehicle having a key operated ignition switch, neutral safety switch, seat belt switch, solenoid and starter, comprising wiring the seat belt switch such that the solenoid is not actuated unless and until the seat belt switch is engaged indicative of a seat belt being connected such that if not connected, the vehicle does not run.

2. The seat belt switching device of claim 1, wherein the seat belt switch has a fastened and unfastened position such that when in a fastened position a circuit is closed to the solenoid, actuating the starter and when in an unfastened position said circuit is open to the solenoid thereby failing to engage the solenoid and failing to permit operation of the vehicle.

3. The seat belt switching device of claim 2, wherein the opening and closing occurs after the neutral safety switch.

4. The seat belt switching device of claim 2, wherein the opening and closing occurs prior to the neutral safety switch.

6. A seat belt switching device for preventing the running of a vehicle having a remote starting ability, key operated ignition switch, neutral safety switch, seat belt switch, solenoid and starter, comprising wiring the seat belt switch such that the solenoid is not actuated unless and until the seat belt switch is engaged indicative of a seat belt being connected such that if not connected, the vehicle does not run.

7. The seat belt switching device of claim 6, wherein the seat belt switch has a fastened and unfastened position such that when in a fastened position a circuit is closed to the solenoid, actuating the starter and when in an unfastened position said circuit is open to the solenoid thereby failing to engage the solenoid and failing to permit operation of the vehicle.

8. The seat belt switching device of claim 7, wherein the opening and closing occurs after the neutral safety switch.

9. The seat belt switching device of claim 7, wherein the opening and closing occurs prior to the neutral safety switch.
